(19) United States
(12) Patent Application Publication
(10) Pub. No.: US 2019/0347672 A1
(43) Pub. Date: Nov. 14, 2019

(54) MEMORY AUGMENTATION IN SUPPORT OF WEB INTERACTIONS

(71) Applicant: International Business Machines Corporation, Armonk, NY (US)

(72) Inventors: Jarir Kamel Chaar, Ardsley, NY (US); David Nahamoo, Great Neck, NY (US)

(21) Appl. No.: 15/975,814

(22) Filed: May 10, 2018

(51) Int. Cl. G06Q 30/02; H04L 29/08; G06F 17/30

(52) U.S. Cl. CPC G06Q 30/0201; G06F 17/30867; H04L 67/22

(57) ABSTRACT

Techniques facilitating memory augmentation in support of web interactions are provided. In one example, a system can comprise a memory that stores computer executable components and a processor that executes the computer executable components stored in the memory. The computer executable components can comprise an analysis component, an augmentation component, and an output component. The analysis component can evaluate one or more interactions associated with an entity with one or more data sources. The augmentation component can integrate details of ongoing interactions between the entities and the data sources with historical interactions. Integration can comprise multiple forms comprising sorted lists of time-stamped events that reflect commonalities such as context and topic. The output component can render a list of alternatives, in response to explicit requests from the entity or proactively while monitoring progress of interactions between the entities and the data sources.

### BACKGROUND

The subject disclosure relates to computing memory, and more specifically, to memory augmentation.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatus, and/or computer program products that facilitate memory augmentation in support of web interactions are described.

According to an embodiment, a system can comprise a memory that stores computer executable components and a processor that executes the computer executable components stored in the memory. The computer executable components can comprise an analysis component that can evaluate one or more interactions with one or more data sources. The one or more interactions can be associated with an entity. Data sources of the one or more data sources can comprise one or more websites and one or more chatrooms. Further, data sources can capture one or more interactions of entities, including the entity, associated with visited websites and chatrooms. The computer executable components can also comprise an augmentation component that can integrate details of ongoing interactions between the entities and the data sources with historical interactions between the entities and the one or more data sources. Integration by the augmentation component can comprise multiple forms comprising sorted lists of time-stamped events that reflect commonalities such as context and topic. The historical interactions can be retained in a storage device. Further, the computer executable components can comprise an output component that can render a list of alternatives, in response to explicit requests from the entity or proactively while monitoring progress of interactions between the entities and the data sources. The list of alternatives can be a single reference source that comprises the integration of the respective details of the interactions and the historical interactions.

According to another embodiment, a computer-implemented method can comprise evaluating, by a system operatively coupled to a processor, one or more interactions with one or more data sources. The one or more interactions can be associated with an entity. The computer-implemented method can also comprise integrating, by the system, details of ongoing interactions between entities, including the entity, and data sources with historical interactions between the entities and the data sources. The integrating can comprise multiple forms comprising sorted lists of time-stamped events that reflect commonalities such as context and topic. Further, the computer-implemented method can comprise rendering, by the system, a list of alternatives, in response to explicit requests from the entity or proactively while monitoring progress of interactions between the entity and the data sources.

According to another embodiment, a computer program product that provides memory augmentation services can comprise a computer readable storage medium having program instructions embodied therewith. The program instructions can be executable by a processing component. The program instructions can cause the processing component to evaluate one or more interactions with one or more data sources. The one or more interactions can be associated with an entity. The program instructions can also cause the processing component to integrate details of ongoing interactions between entities, including the entity, and data sources with historical interactions between the entities and the data sources. The integration of the details can comprise multiple forms comprising sorted lists of time-stamped events that reflect commonalities such as context and topic. Further, the program instructions can cause the processing component to render a list of alternatives, in response to explicit requests from the entity or proactively while monitoring progress of interactions between the entity and the data sources. The list of alternatives can be a single reference source that comprises an integration of the respective details of the interactions and the historical interactions.

### DESCRIPTION OF THE DRAWINGS

FIG. 1 illustrates a block diagram of an example, non-limiting, system that facilitates memory augmentation in support of web interactions in accordance with one or more embodiments described herein.

FIG. 2 illustrates a block diagram of an example, non-limiting, system that facilitates memory augmentation for audio content and verbal content in accordance with one or more embodiments described herein.

FIG. 3 illustrates a block diagram of an example, non-limiting, system that facilitates memory augmentation for audio content, text content, and visual content in accordance with one or more embodiments described herein.

FIG. 4 illustrates a block diagram of an example, non-limiting, system that facilitates insights associated with memory augmentation for audio content, text content, and visual content in accordance with one or more embodiments described herein.

FIG. 5 illustrates a block diagram of an example, non-limiting, system that facilitates memory augmentation for a sequence of inputs and outputs during a defined time interval in accordance with one or more embodiments described herein.

FIG. 6 illustrates an example, non-limiting, representation of a system of hybrid memory augmentation of a website and/or chat room in accordance with one or more embodiments described herein.

FIG. 7 illustrates an example, non-limiting, representation of a system of direct memory augmentation of a website and/or chat room in accordance with one or more embodiments described herein.

FIG. 8 illustrates a memory augmentation services portal in accordance with one or more embodiments described herein.

FIG. 9 illustrates a block-diagram of an example, non-limiting, system for cloud-based memory augmentation services in accordance with one or more embodiments described herein.

FIG. 10 illustrates an example, non-limiting, data model in accordance with one or more embodiments described herein.

FIG. 11 illustrates a flow diagram of an example, non-limiting, computer-implemented method that facilitates memory augmentation in support of web interaction in accordance with one or more embodiments described herein.

FIG. 12 illustrates a flow diagram of an example, non-limiting, computer-implemented method that facilitates memory augmentation for audio content and verbal content in accordance with one or more embodiments described herein.

FIG. 13 illustrates a flow diagram of an example, non-limiting, computer-implemented method that facilitates memory augmentation for audio content, text content, and visual content in accordance with one or more embodiments described herein.

FIG. 14 illustrates a flow diagram of an example, non-limiting, computer-implemented method that facilitates insights associated with memory augmentation for audio content, text content, and visual content in accordance with one or more embodiments described herein.

FIG. 15 illustrates a flow diagram of an example, non-limiting, computer-implemented method that facilitates memory augmentation for sets of inputs and outputs during a defined time interval in accordance with one or more embodiments described herein.

FIG. 16 illustrates a flow diagram of an example, non-limiting, computer-implemented method for memory augmentation in accordance with one or more embodiments described herein.

FIG. 17 illustrates a block diagram of an example, non-limiting operating environment in which one or more embodiments described herein can be facilitated.

FIG. 18 depicts a cloud computing environment in accordance with one or more embodiments described herein.

FIG. 19 depicts abstraction model layers in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

The various aspects discussed herein relate to a suite of secure and automated subscription services that can track, annotate, and analyze historical and ongoing interactions (e.g., surfing, search, and conversations with automated and human sources of knowledge), decisions, and/or long-running transactions that involve a multitude of e-commerce sites and are initiated from a variety of communication devices (e.g., Personal Computers (PCs), Personal Data Assistants (PDAs) in order to learn its user's preferences, inform and optimize their future decisions, and improve overall product search and discovery processes. As such and for frequent visitors, these services can be expected to, over time and across sites, help speed up their searches for high quality information, predict better their shopping needs, and proactively recommend products and potential alternatives.

The capabilities afforded by above services, referred to as memory augmentation services, can be implemented as Jupyter Notebooks/Networks, for example, and can offer subscribers an integrated suite of annotation, summarization, dialog management, and transaction management capabilities.

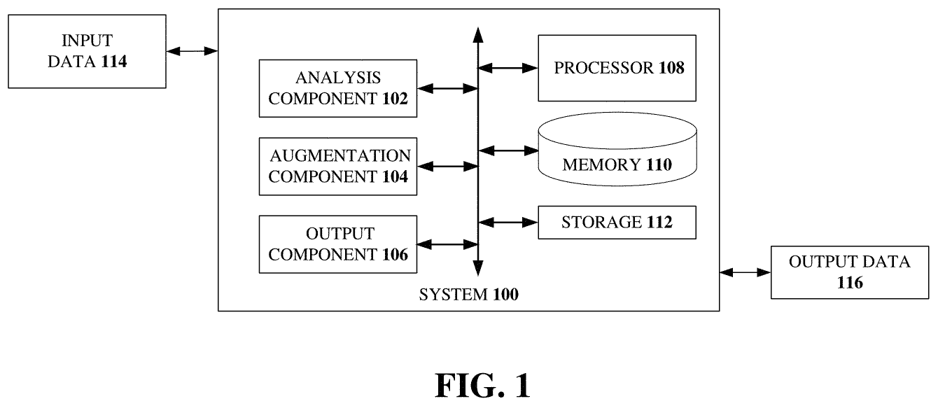

FIG. 1 illustrates a block diagram of an example, non-limiting, system 100 that facilitates memory augmentation in support of web interactions in accordance with one or more embodiments described herein. Aspects of systems (e.g., the system 100 and the like), apparatuses, or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

In various embodiments, the system 100 can be any programmable digital or analog device that comprises a processor and is capable of effectively and/or operatively interface with a wired and/or wireless communication network. Such devices can include, but are not restricted to Internet-enabled tablets, handheld devices, smart phones, digital assistants, consumer appliances, game consoles, laptops, notebooks, desktops, application and database servers.

As illustrated, the system 100 can comprise an analysis component 102, an augmentation component 104, an output component 106, a processor 108, a memory 110, and/or a storage 112. In some embodiments, one or more of the analysis component 102, the augmentation component 104, the output component 106, the processor 108, the memory 110, and/or the storage 112 can be communicatively and/or operatively coupled to one another to perform one or more functions of the system 100.

The analysis component 102 can receive, as input data 114, one or more of the interactions between individual subscribers and one or more Internet data sources. Moreover, the respective details of ongoing interactions can also be aggregated with prior interactions (e.g., historical interaction details) by the augmentation component 104.

The data sources can cover a wide range of functions offered by websites across the Internet. These functions can range from news and social media to travel and entertainment to ecommerce transactions. The data captures the interactions of websites with entities ranging from human beings to Artificial Intelligence (AI) agents and ibots that are associated with visited websites. In a specific, non-limiting example, the entity can be individual subscribers seeking to inform and optimize their future decisions.

The augmentation component 104 can integrate the details of ongoing interactions between entities and data sources with past (or historical) interactions between the same parties. The integration by the augmentation component 104 can take multiple forms including the creation and management of the full history of such interactions as sorted lists of time-stamped events that reflect commonalities such as context and topic. These lists can be retained in a storage device (e.g., the storage 112), which can be a storage device that meets global and local data security and privacy requirements.

Further, the output component 106 can render, as output data 116, a list of choices that can be generated and scored by the analysis component 102, working in tandem with the augmentation component 104, to formulate a set of alternatives in response to explicit requests from the entity that are expressed as input data 114, or proactively while monitoring the progress of interactions between the entity and the data sources.

In an example, the one or more interactions can comprise inputs received from the entity and outputs provided by the one or more data sources. The inputs and the outputs can comprise speech, utterance, text, image, video, touch, gesture, and annotations, or a combination thereof.

The inputs received from the entity and the outputs provided by the one or more data sources can be represented as data streams. According to an implementation, the data streams can be related to free-flowing chats and the analysis component 102 can independently evaluate the data streams. In an additional, or alternative, implementation, the data streams can be related to structured web surfing and the analysis component 102 can evaluate the data streams as an aggregate set of data streams.

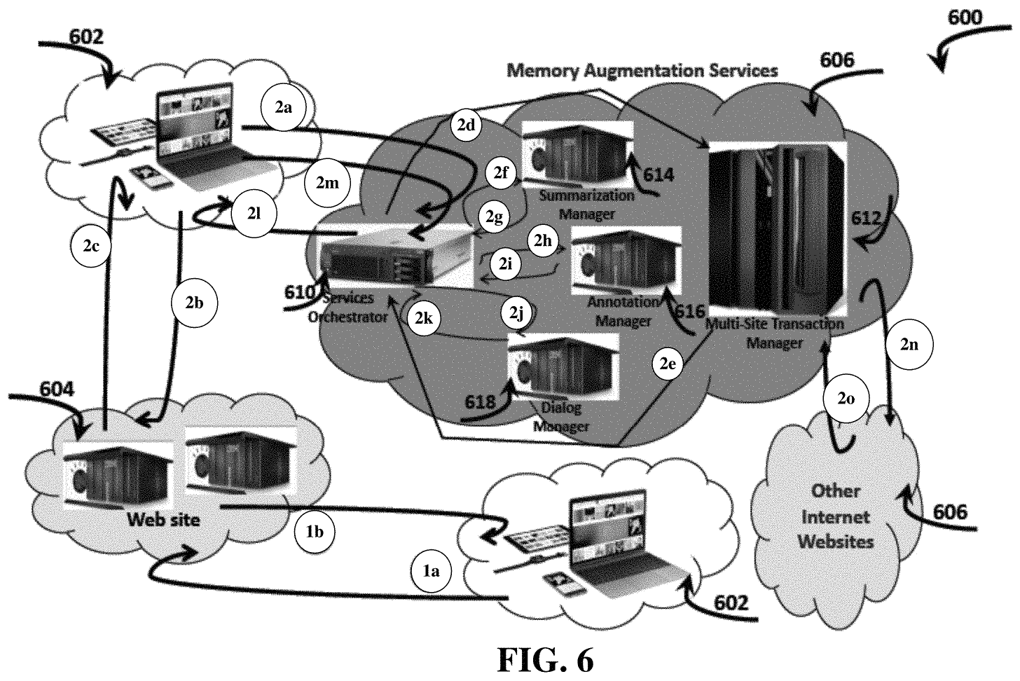

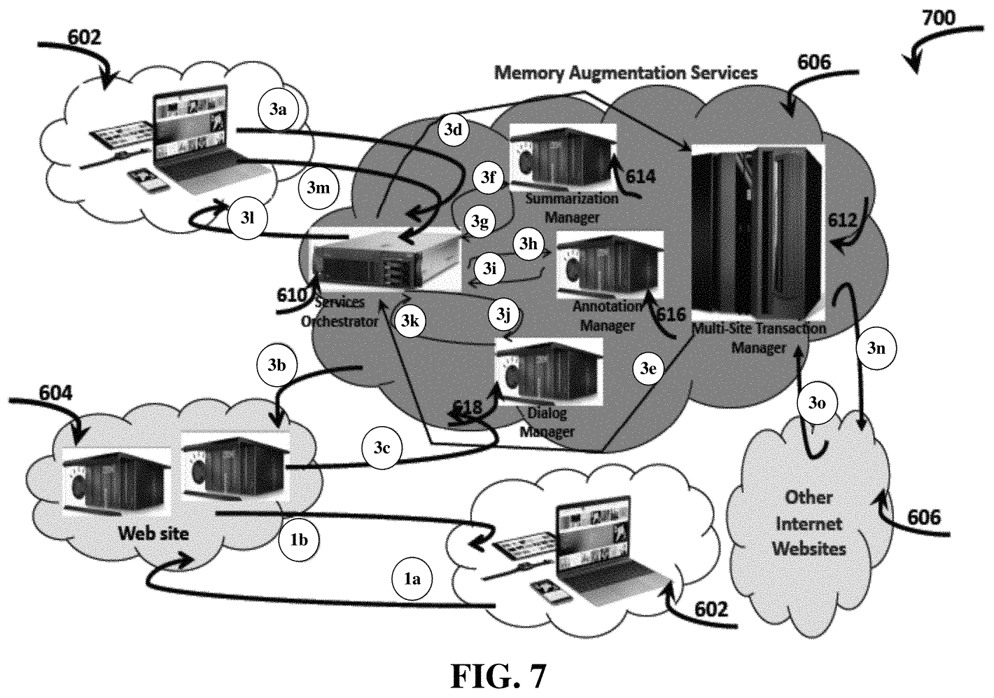

The system 100 can be offered as a service to individual Internet users by a cloud services provider and/or by business entities interested in improving customer loyalty (e.g., retailers, travel agencies, insurance companies). For example, the system 100 can be configured as a hybrid memory augmentation, which will be discussed below with respect to FIG. 6. In another example, the system 100 can be configured as a direct memory augmentation, which will be discussed below with respect to FIG. 7.

According to an example, the analysis component 102 can evaluate one or more interactions with one or more data sources. The one or more interactions can be associated with a defined entity. The data sources can cover a wide range of functions offered by websites across the Internet. These functions can range from news and social media to travel and entertainment to ecommerce transactions. The data captures the interactions of websites with entities ranging from human beings to Artificial Intelligence (AI) agents and ibots that are associated with visited websites. In a specific, non-limiting example, the entity can be individual subscribers seeking to inform and optimize their future decisions.

Further to this example, the augmentation component 104 can integrate the details of ongoing interactions between entities and data sources with past (or historical) interactions between the same parties. The integration by the augmentation component can take multiple forms including the creation and management of the full history of such interactions as sorted lists of time-stamped events that reflect commonalities such as context and topic. These lists can be retained in a storage device that meets global and local data security and privacy requirements. The output component 106 can render a list of choices that can be generated and scored by the analysis component 102, working in tandem with the augmentation component 104, to formulate a set of alternatives, in response to explicit requests from the entity or proactively while monitoring the progress of interactions between the entity and the data sources.

If memory augmentation is enabled by an Internet website or chat room, a significant number of the artifacts that are used in interactions between visitors and the website or the chat room can be generated and continually updated by the system. This backend processing can help improve the overall scalability and performance of the system.

The systems and/or the components of the systems discussed herein can be employed to use hardware and/or software to solve problems that are highly technical in nature (e.g., track, annotate, and analyze historical and ongoing electronic activities (e.g., searching, surfing, communicating)), that are not abstract and that cannot be performed as a set of mental acts by a human. For example, multiple electronic interactions associated with a multitude of communication devices can be simultaneously monitored, analyzed, annotated, and/or other functions can be performed, which cannot be determined as a set of mental acts. Further, some of the processes can be performed by specialized computers for carrying out defined tasks related to the memory augmentation. For example, a human, or even thousands of humans, cannot efficiently, accurately and effectively manually access, analyze, and perform tasks associated with the large number of electronic interactions, which can occur between devices located at disparate geographic locations. The various systems and/or components of the systems can be employed to solve new problems that arise through advancements in technology, computer networks, the Internet and the like. The various systems can provide technical improvements to knowledge sources that can be visited a multitude of times for different searches for information. Even if an extensive number of websites are bookmarked, the overall search and discovery process can be overwhelming due to the high volume of the searches, as well as the large amount of data that can be searched. In addition, the various aspects cannot be performed by a human (e.g., using approaches that are greater than the capability of a single human mind). For example, the amount of data processed, the speed of processing of the data, and/or the electronic data types processed over a certain period of time can be respectively greater, faster, and different than the amount, speed and data type that can be processed by a single human mind over the same period of time.

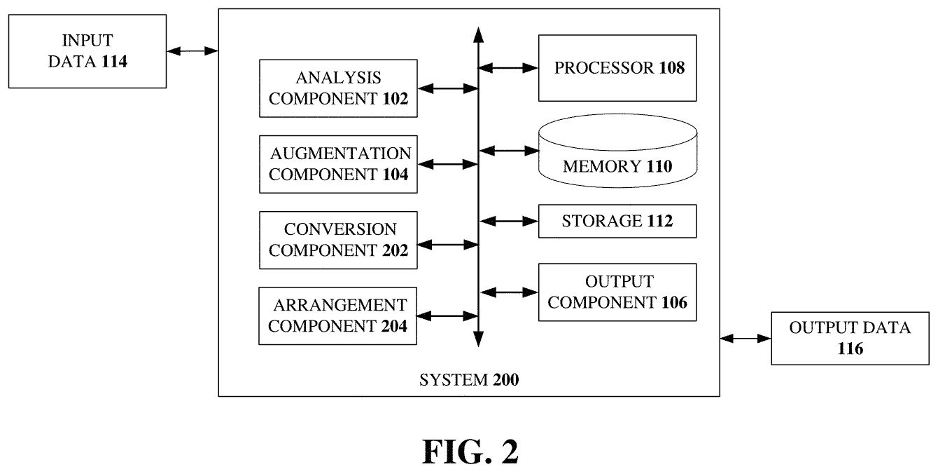

FIG. 2 illustrates a block diagram of an example, non-limiting, system 200 that facilitates memory augmentation for audio content and verbal content in accordance with one or more embodiments described herein. Repetitive description of like elements employed in other embodiments described herein is omitted for sake of brevity. The system 200 can comprise one or more of the components and/or functionality of the system 100, and vice versa.

As illustrated, the system 200 can comprise a conversion component 202 and an arrangement component 204. The one or more interactions evaluated by the analysis component 102 can comprise inputs received from the defined entity and outputs provided by the one or more data sources. For example, the inputs received from an entity (e.g., a user communicating through their computing device) can include a search request, a text string, or other data that can be indicative of a request or action to be performed by the defined entity (e.g., a website). According to various aspects, the inputs and the outputs can comprise audio content and verbal content.

The conversion component 202 can identify the portions of the inputs and/or outputs that comprise verbal content. Upon or after the identification of the verbal content, the conversion component 202 can translate the verbal content into text. For example, the conversion component 202 can comprise a speech to text engine that can automatically transform the content from a verbal format (e.g., speech, utterance) to text.

Upon or after the conversion component 202 transforms the content, the arrangement component 204 can align the text with the audio content, which can be retained in a storage device (e.g., the memory 110). Thus, the original content can be a single copy (e.g., verbal content) of the interaction and the saved content can comprise the original content and the new content (e.g., the content in text format).

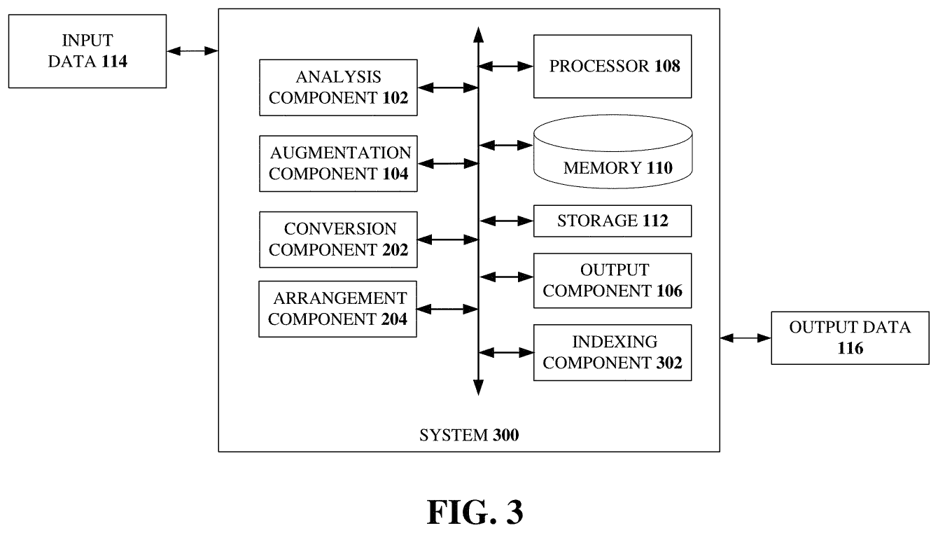

FIG. 3 illustrates a block diagram of an example, non-limiting, system 300 that facilitates memory augmentation for audio content, text content, and visual content in accordance with one or more embodiments described herein. Repetitive description of like elements employed in other embodiments described herein is omitted for sake of brevity. The system 300 can comprise one or more of the components and/or functionality of the system 100, the system 200, and vice versa.

In this example, the one or more interactions evaluated by the analysis component 102 can comprise inputs received from an entity and outputs provided by the one or more data sources. The inputs and the outputs can comprise audio content, text content, and visual content.

The system 300 can integrate, configure, and deploy a suite of services that capture and analyze historical interactions of individuals or groups of subscribers with a website in order to inform and optimize (e.g., assist) future decisions by the one or more subscribers during a subsequent interaction with the same (or a similar) website. In an example, assisting the future decision can be performed passively and/or actively.

An indexing component 302 can apply respective semantic markers that derive the context of one or more interactions between an entity and its visited website. According to some implementations, the indexing component 302 can be included, at least partially, in the augmentation component 104. Markers can be applied to the inputs and the outputs of the indexing component 302 based on the audio content, the text content, and the visual content. For example, the indexing component 302 can process the audio content, the text content, and the visual content and create and update semantic markers, extracted insights, and summaries of the recorded interactions.

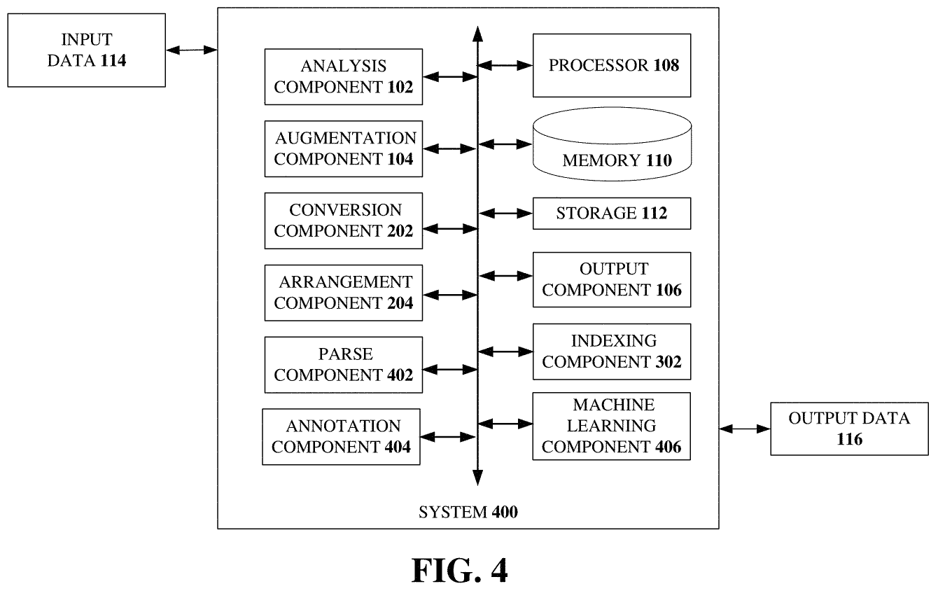

FIG. 4 illustrates a block diagram of an example, non-limiting, system 400 that facilitates insights associated with memory augmentation for audio content, text content, and visual content in accordance with one or more embodiments described herein. Repetitive description of like elements employed in other embodiments described herein is omitted for sake of brevity. The system 400 can comprise one or more of the components and/or functionality of the system 100, the system 200, the system 300, and vice versa.

The one or more interactions evaluated by the analysis component 102 can comprise inputs received from an entity and outputs provided by one or more data sources. In various implementations, the inputs and the outputs can comprise audio content, text content, and visual content.

As illustrated, the system 400 can comprise a parse component 402, an annotation component 404, and a machine learning and reasoning component 406. The parse component 402 can extract respective data from the inputs and the outputs based on the audio content, the text content, and the visual content. For example, the extracted data can comprise insights and/or summaries of the recorded interactions. The annotation component 404 can apply respective summaries to the inputs and the outputs based on the respective data. The respective summaries can be retained with the interactions in a storage device (e.g., the storage 112).

The machine learning and reasoning component 406 can perform a set of machine learning computations associated with the input data 114 and/or the output data 116. For example, the machine learning and reasoning component 406 can evaluate interactions with a website and integrate details of the interactions with historical interactions. Further, the machine learning and reasoning component 406 can output a configurable profile or a list of alternatives based on a request to access the website.

The machine learning and reasoning component 406 can utilize machine learning systems that have been explicitly or implicitly trained to learn, determine or infer system (or entity) interactions, historical data, websites, feedback based on historical recommendations, and so on, that achieve meaningful recommendations for future decisions of an entity. The meaningful recommendations can be passively communicated and/or actively contributed. It is to be noted that a variety of learning techniques, including but not limited to machine learning, deep learning, and reinforcement learning systems can be selectively implemented in one or more of the components to generate explicitly and/or implicitly trained models that provide the desired passive and/or active assistance related to one or more websites and/or interactions with the websites.

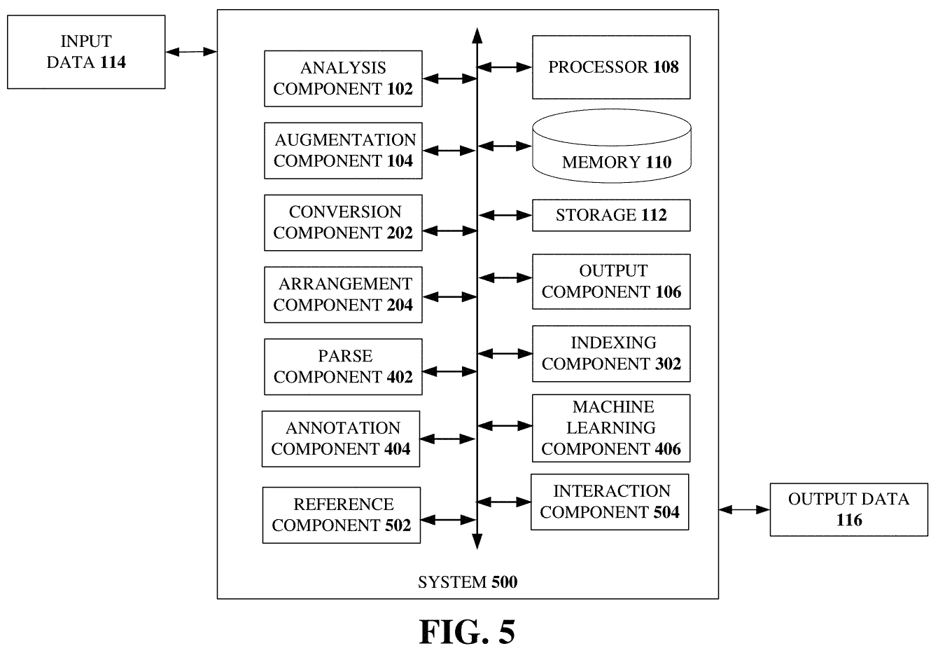

FIG. 5 illustrates a block diagram of an example, non-limiting, system 500 that facilitates memory augmentation for a sequence of inputs and outputs during a defined time interval in accordance with one or more embodiments described herein. Repetitive description of like elements employed in other embodiments described herein is omitted for sake of brevity. The system 500 can comprise one or more of the components and/or functionality of the system 100, the system 200, the system 300, the system 400, and vice versa.

The system 500 can comprise a reference component 502 and an interaction component 504. The one or more interactions evaluated by the analysis component 102 can comprise inputs received from the defined entity and outputs provided by the one or more data sources. The reference component 502 can associate respective time reference markers to the inputs and the outputs. For example, the respective time reference markers can indicate a day, time, year, day of week, and/or other temporal information associated with the inputs and outputs. In some implementations, the respective time reference markers can be utilized during a search function (e.g., historical search of previous interactions). According to some implementations, the reference component 502 can be included, at least partially, in the augmentation component 104.

The interaction component 504 can retrieve a first set of the inputs and a second set of the outputs for a defined time interval in response to a query that includes the defined time interval. The first set of the inputs and the second set of the outputs can be retrieved based on the respective time reference markers that correspond to the defined time interval. For example, a request can be received for inputs and outputs generated last Saturday. Based on this request, the interaction component 504 can return only the inputs and outputs that have a time stamp (provided by the reference component 502) that indicate the inputs and outputs were generated last Saturday.

As discussed herein, the various aspects provide for developing, configuring, and deploying a suite of services that can capture and analyze prior interactions of any individual subscriber with a website in order to inform and optimize their future decisions when interacting with the same commerce site. Interactions can include any individual subscriber's input per turn and the system's output per turn. In an example, the interactions of any individual subscriber with multiple commerce sites can be aggregated in order to inform and optimize their decisions when interacting with any of these commerce sites. Further to this example, both input and output can be represented as data streams that can be independently manipulated, as in free-flowing chats, or, manipulated in aggregate, as in more structured web surfing. The data streams could include speech, utterance, text, image, video, touch, gesture, and any annotations applied to the captured static and dynamic content of the commerce site. The recorded spoken content can be transcribed through an automatic speech to text engine and the transcribed text can be stored in alignment with the audio content. Further, the speech, text, and visual content can be processed to create semantic markers, extracted insights, and summaries of the recorded interaction. The various aspects can actively and/or passively assist the individual subscriber.

In an example, the various aspects can enable the retrieval, among other things, of the interactions, related semantics markers, summaries, and annotations by creating and storing a time-stamped copy of all the mentioned content. In another example, both native and browser-based applications, with different configurations of connectivity between the user's device, the visited website, and the memory augmentation services site can be supported with the disclosed aspects.

In further detail, FIG. 6 illustrates an example, non-limiting, representation of a system 600 of hybrid memory augmentation of a website and/or chat room in accordance with one or more embodiments described herein. Repetitive description of like elements employed in other embodiments described herein is omitted for sake of brevity. The system 600 can comprise one or more of the components and/or functionality of the system 100, the system 200, the system 300, the system 400, the system 500, and vice versa.

FIG. 6 highlights the Hybrid Memory Augmentation configuration that can be used by service providers. As part of activating their subscription, users can be guided through an installation process that can enhance their browser(s) or can upgrade their mobile application(s) with support for the services selected from a menu of standard and custom offering elements. In this configuration, memory augmentation services can be hosted on a server and have no direct access to the content of the webpages visited by the subscriber. Any prior content used to enhance the visited pages can be collected by the server and integrated and rendered on the user's device. Additional content, generated during the visit, can be collected and sent back, together with the visited webpage to the server where it can be timestamped and added to the history of interactions between user and website.

The memory augmentation services discussed herein can offer commerce site developers and data analysts programmatic access to a number of mechanisms that collect and analyze historical interactions, decisions, and/or transactions of Internet users in order to inform their ongoing activities. The gathered information can be contextual in nature and can comprise summaries, annotations, dialog segments, and e-commerce transactions that can be linked to a single webpage or chat room, a path comprising a chronology of webpages within a single website, or a chat window within a chat room, or a chronology of websites within a single web session or a chronology of chat rooms within a single chat session. This information is subsequently used by the memory augmentation services to answer subscribers' queries and/or to proactively send subscribers timely advice.

According to various implementations, memory augmentation services of annotation, summarization, dialog management, and transaction management can be offered as cloud-based services. Thus, when Internet users subscribe to the memory augmentation services, the users can use their browsers and/or mobile applications to enable/disable one or more of these services. Tracking the browsing history of subscribers and their e-commerce transactions can be always enabled, independent of whether other memory augmentation services are enabled or not enabled.

While most common types of tracking technologies, such as, cookies, click redirects, image tags, and tag containers can continue to be used for marketing attribution, the disclosed aspects can leverage one or more web applications that can capture and manage the full history of respective interactions of the subscribers to the service with commerce sites. In an example, an open source web application that can be utilized is the Jupyter Notebook, which is an open-source web application that allows developers to create and share documents that contain live code, equations, visualizations, and explanatory text. Uses include data cleaning and transformation, numerical simulation, statistical modeling, machine learning and much more. Respective networks (e.g., a Jupyter Network) can be maintained for the subscribers to the memory augmentation services. The nodes of this network can comprise documents (e.g., Jupyter Documents). The various documents can capture, in sequence, the webpages in the commerce website that were accessed by the subscriber during a web session. Accessing a page of the commerce site can signal the start of a web session. The end of a web session can be marked by accessing a webpage outside the commerce site tree structure of webpages or a closing of the browser window.

The disclosed aspects (e.g., memory augmentation services) can utilize time-stamping and can save the content (both static and dynamic) and the artifacts (e.g., summaries, annotations, dialogs, and transactions) of the pages visited by subscribers. Such information can be utilized to understand the preferences and to predict (e.g., infer) the future shopping needs of subscribers. As such, a browsing session can be captured (e.g., as a Jupyter Notebook in the Jupyter Network) that is dedicated to the subscriber. A full scan of the commerce website, together with the full sequence of time-stamped webpage modifications it underwent can be retained by the service (e.g., in the memory 110). This can allow the code of the Notebook to use its saved Uniform Resource Locator (URL) to regenerate the page visited by a subscriber. Once the page is re-constituted, its parameter values and artifacts can also be retrieved from the Notebook and displayed.

With continuing reference to FIG. 6, the system 600 can comprise one or more user devices (e.g., computing devices, subscriber's device 602), one or more websites 604, memory augmentation services 606, and other internet websites 608. The memory augmentation services 606 can comprise a services orchestrator component 610, a transaction manager component 612, a summarization manager component 614, an annotation manager component 616, and a dialog manager component 618.

The following will discuss the steps involved in leveraging memory augmentation as a hybrid service to enhance traditional website and chat room interactions, as illustrated in FIG. 6. The one or more user devices (e.g., the subscriber's device 602) can communicate to the one or more websites 604, as indicated at step 1a, and can receive data from the one or more websites 604, as indicated at step 1b.

When an Internet user subscribes to memory augmentation services as discussed herein, a memory augmentation plugin can be installed on their active browsers or the memory augmentation application can be installed on their mobile devices. This plugin can comprise a JavaScript code that calls the Application Programming Interfaces (APIs) of the memory augmentation services 606 hosted in the cloud. This code implements the equivalent of a tags container, which is a code snippet used in web development that removes the need for multiple data tracking codes being placed directly on the site. Instead, one code is placed on every page on a site.

A (cross-domain) tracking tag of the container can be implemented as a beacon using, for example, the w3c specification, which defines an interface that web developers can use to schedule asynchronous and non-blocking delivery of data that minimizes resource contention with other time-critical operations, while ensuring that such requests can be still processed and delivered to a destination. This tag can be used to transmit the Internet address (URL) to the memory augmentation cloud server in order to retrieve prior visits' artifacts.

In the hybrid memory augmentation of FIG. 6, step 2a transmits the URL of the webpage to the memory augmentation server. In parallel, steps 2b and 2c can deliver the webpage content to the requesting browser application or mobile application directly from its website.

With reference also to FIG. 7, which illustrates an example, non-limiting, representation of a system 700 of direct memory augmentation of a website and/or chat room in accordance with one or more embodiments described herein. Repetitive description of like elements employed in other embodiments described herein is omitted for sake of brevity. The system 700 can comprise one or more of the components and/or functionality of the system 100, the system 200, the system 300, the system 400, the system 500, the system 600, and vice versa.

FIG. 7 highlights the Direct Memory Augmentation configuration used by business entities. As part of setting up the service for the business entity, many of the service elements can be created and/or updated a-priori and, for the duration of the augmented services contract, as soon as content is updated on the business entity's website. This step can help improve the efficiency and scalability of the augmented services associated with the business entity's website. During set up and for the duration of the augmented services contract, cookies or tags are also created and subsequently associated with webpages of the business entity's website. These cookies/tags can point subscribers to a version of the website that has been enhanced with prior interactions they had with this website. When activating their subscription, users can be guided through an installation process that can enhance their browser(s) or can upgrade their mobile application(s) with support for the services selected from a menu of standard and custom offering elements. In this configuration, memory augmentation services can be hosted on a server and can have direct access to the content of the webpages visited by the subscriber. Any prior content used to enhance the visited pages can be collected and integrated by the server and can be rendered on the user's device. Additional content, generated during the visit, can be collected and sent back to the server where it can be timestamped and added to the history of interactions between user and website.

FIG. 7 details the steps involved in directly leveraging memory augmentation to enhance traditional website and chat room interactions. In the direct memory augmentation of FIG. 7, step 3a transmits the URL of the webpage to the memory augmentation server. Next, steps 3b and 3c deliver the webpage content to the memory augmentation server which acts as the requesting browser application or mobile application for its website. It is noted that steps 3b and 3c establish a direct connectivity between a subscribing website of the websites 604 and the memory augmentation services 606, which in turn, is used to reflect, a-priori, changes in the website structure and/or content on the artifacts associated with the services. This step is not enabled in the hybrid model because the website visited by an individual subscriber is not aware of memory augmentation services.

With continuing reference to FIG. 6 and FIG. 7, for the annotation, summarization, dialog management, and transaction management services, respective pixel tags of the container can be defined. Pixel tags (also referred to as clear GIFs, web beacons, or pixels) can be small blocks of code on a webpage that allow websites to perform operations, such as read and place cookies. The resulting connection can include information such as the computing device's IP address, the time the pixel was rendered on the computing device and the type of browser being used. For one or more enabled services, the pixel tags can be used to create or retrieve the artifacts associated with the URL transmitted in step 2a of FIG. 6 in order to be rendered by the subscriber's browser application or mobile application.

In the hybrid memory augmentation of FIG. 6, step 2l transmits the artifacts associated with the webpage from the services orchestrator component 610 of the subscriber's device 602. For one or more enabled services, its pixel tag can be used to communicate to the services orchestrator component 610 the need to collect and transmit associated data. Except for webpage summaries, which reflect the webpage content and can be shared with all subscribers to the service, other artifacts can be kept private and collected based on the prior interactions of a subscriber with a webpage. The webpage URL can be used by steps 2d and 2e to retrieve past transactions using the transaction manager component 612. Steps 2f and 2g use the URL to retrieve a summary, if available, of the current version of the webpage from the summarization manager component 614. Steps 2h and 2i can use the URL to retrieve past annotations of the webpage from the annotation manager component 616. Steps 2j and 2k can use the URL to retrieve past dialog segments related to the webpage from the dialog manager component 618. As such, the prior artifacts transmitted in step 2l can be added by the requesting browser application or mobile application to the content from steps 2b and 2c. Note that a first visit to the webpage returns only a summary of the webpage and allocates specific areas in the browser application or mobile application for additional artifacts.

In the direct memory augmentation of FIG. 7, step 3l transmits the artifacts associated with the webpage from the subscriber's device 602. For one or more enabled service, its pixel tag can be used to communicate to the services orchestrator component 610 the need to collect and transmit associated data. Except for webpage summaries, which reflect the webpage content and can be shared with all subscribers to the service, other artifacts can be kept private and can be collected based on the prior interactions of a subscriber with a webpage. The webpage URL is used by steps 3d and 3e to retrieve past transactions using the transaction manager component 612. Steps 3f and 3g use the URL to retrieve a summary, if available, of the current version of the webpage from the summarization manager component 614. Steps 3h and 3i use the URL to retrieve past annotations of the webpage from the annotation manager component 616. Steps 3j and 3k use the URL to retrieve past dialog segments related to the webpage from the dialog manager component 618. The prior artifacts can be then added to the webpage content from steps 3b and 3c before being transmitted in step 3l and rendered by the requesting browser application or mobile application. A first visit to the webpage returns only a summary of the webpage and allocates specific areas in the browser application or mobile application for additional artifacts.

With continuing reference to FIG. 6 and FIG. 7, when the subscriber navigates to a linked webpage within a website or to a new website, the pixel tags, in turn, update their associated artifacts on the memory augmentation servers (step 2m of FIG. 6 and step 3m of FIG. 7). At the website level, the number of artifacts can be reflective of the number of unique paths traveled within the site or the number of times a single path is traveled within that same site.

It is noted that the memory augmentation services 606 could search the public Internet for comparative data in response to queries from their subscribers and/or to help provide the rationale behind the conclusions. Step 2n in FIG. 6 issues a request for such data, which is transmitted back to the memory augmentation server in step 2o. Similarly, step 3n in FIG. 7 issues a request for such data, which is transmitted back to the memory augmentation server in step 3o. Such data can be combined with the data collected in steps 2d-2k and transmitted in step 2l of FIG. 6 or the data collected in steps 3d-3k and transmitted in step 3l of FIG. 7.

Memory augmentation services can be both compute and storage intensive. As such, it can benefit from the automatic provisioning and deployment of hardware resources (Infrastructure as a Service) and middleware resources (Platform as a Service) that can be part of cloud computing. A two-tier implementation of the memory augmentation services comprises a browser plugin or mobile application, which can be used to manage access to the cloud-based applications implementing such services. Internet users can download a browser plugin or a mobile application in order to subscribe to and configure the memory augmentation services. Once configured, subscribers can use their browser application or mobile application to turn on and off one or more of these services. Services include, but are not limited to, summarization, annotation, and dialog management. The services can enhance traditional functions, such as transaction management, marketing attribution, and search and discovery. The browser plugin or mobile application can be also used to authenticate users and retrieve the service levels to which they are entitled.

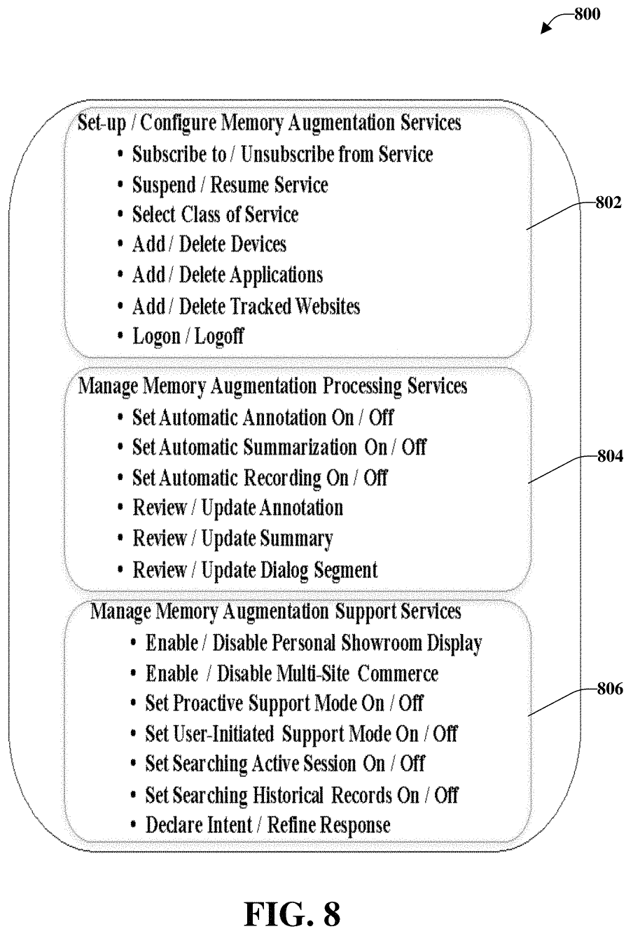

FIG. 8 illustrates a memory augmentation services portal 800 in accordance with one or more embodiments described herein. Illustrated are a list of services that can be selected by subscribers from the memory augmentation services browser or mobile application. These services can be classified into three functional categories: set-up/configuration services, processing services, and support services.

The “Set-up/Configure Memory Augmentation Services” menu 802 of FIG. 8 can enable a user to subscribe, suspend, resume, and/or unsubscribe to memory augmentation services. In some implementations, only active subscribers can benefit from memory augmentation services. Suspending a subscription can preserve the current configuration and archives the data of a user. Both configuration and data can be restored to their latest state when a user resumes his or her subscription. Unsubscribing from the service can trigger a wholesale transfer of private data to its owner before shutting down his or her account.

Once active, a subscriber can login to/logout from the service using the appropriate credentials (e.g., verifiable credentials). Once logged in to the service, subscribers can select a class of service that covers the priorities with which their services can be performed (e.g., instantaneous or delayed insight analysis) and their resources can be provisioned (e.g., processing, storage, network, backup and recovery). The devices used by the subscriber can be also identified in order for the service to keep a consistent state across such devices and enable the start of an interaction on one device and its continuation on another. Tools and processes for capturing, processing, storing and retrieving subscriber data can be also specified. A subscriber can also identify the websites where he/she wants to automatically enable memory augmentation services. The list of such websites can be continually updated with new site addresses when the subscriber visits a site for the first time.

The “Manage Memory Augmentation Processing Services” menu 804 of FIG. 8 can enable an active subscriber to turn on or turn off automatic annotation, summarization, and/or dialog analysis between the subscriber and the real or virtual agent of a website. When off, these capabilities have to be explicitly invoked by the subscriber. Otherwise, these capabilities can be automatically performed upon or after a new webpage is loaded. When a path is formed by clicking links in a webpage, a summary at the website level can be created upon or after the path is completed by clicking a link outside the current webpage content or typing a new website address, which can start a new web session for the subscriber. In addition, subscribers can also review and/or update the summaries, annotations, and dialog segments created by the service.

The “Manage Memory Augmentation Support Services” menu 806 of FIG. 8 can enable an active subscriber to specify the modes of support requested from the service in their ongoing conversations or when preparing for future conversations with real or virtual website agents. Such support can be either made available proactively, or can be initiated by a subscriber, or both. Furthermore, the service can search the segments of an active dialog session, historical records, or both, for support information that relates to the topic or topics of a negotiation or a transaction. Subscriber-initiated searches can require a declaration of intent. Subscribers also can provide feedback on and refine the response generated by the service.

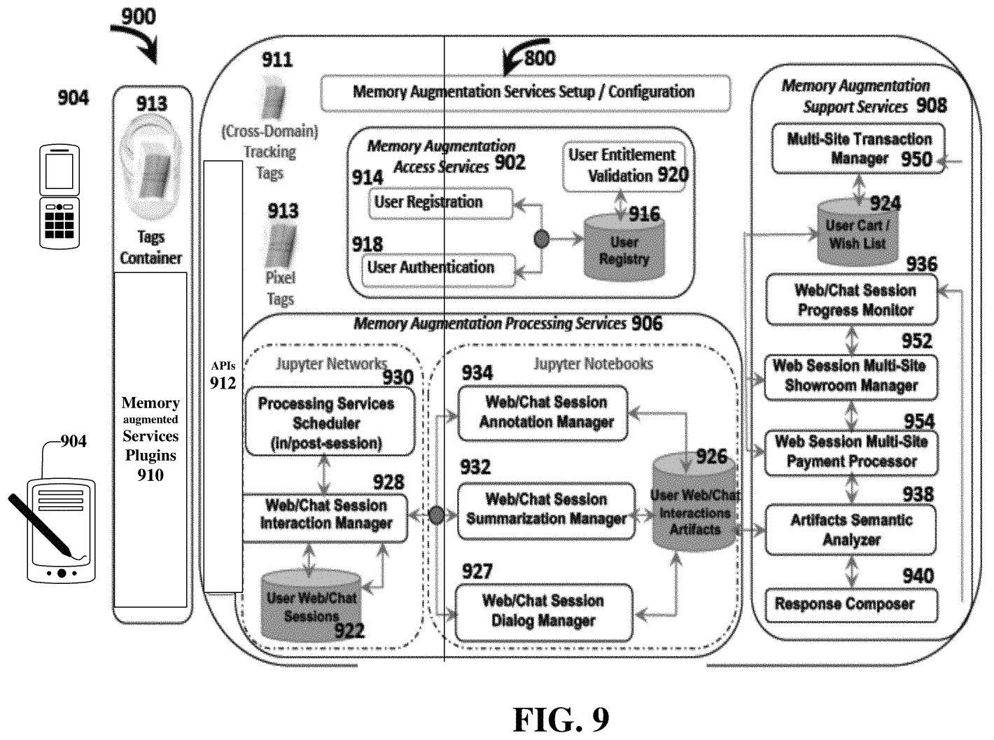

FIG. 9 illustrates a block-diagram of an example, non-limiting, system 900 for cloud-based memory augmentation services in accordance with one or more embodiments described herein. Repetitive description of like elements employed in other embodiments described herein is omitted for sake of brevity. The system 900 can comprise one or more of the components and/or functionality of the system 100, the system 200, the system 300, the system 400, the system 500, the system 600, the system 700, and vice versa.

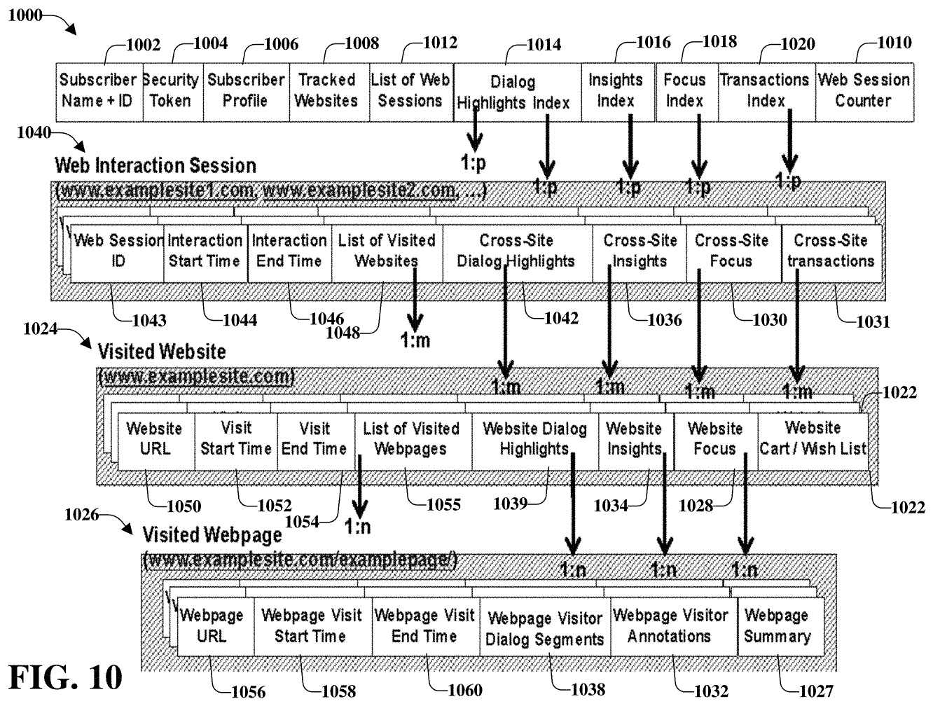

The building blocks of the cloud-based memory augmentation services component are identified in FIG. 9. Memory augmentation access services 902 can be used to authenticate one or more subscribers 904 (e.g., through respective communication devices) and retrieve the list of services to which the subscribers 904 are entitled. In addition to website tracking and transaction management, memory augmentation processing services 906 can be used to capture annotations, analyze dialogs, and derive summaries of webpages and websites. Memory augmentation support services 908 can be used to support ongoing interactions and/or to prepare for future interactions. These services can be managed through a subscriber's memory augmentation services browser plugin or mobile application 910, which can be used to enable/disable calling the memory augmentation services APIs 912. The memory augmentation services APIs 912 can perform the actions triggered by the tracking tags 911 and (cross-domain) pixel tags 913. The tracking tags 911 and pixel tags 913 can be used to coordinate the execution of the code embedded into Jupyter Notebooks, for example. These notebooks can be the nodes of a Jupyter Network that can be maintained for one or more subscribers. FIG. 10 illustrates an example, non-limiting, data model 1000 in accordance with one or more embodiments described herein. The data model 1000 can represent the data component of a Jupyter Notebook and can be managed by the code embedded in the Notebook.

With continuing reference to both FIG. 9 and FIG. 10, a user registration component 914 can be invoked when an Internet user registers as a new subscriber with the memory augmentation services. The registration process can create and store in a user registry 916, in the form of a Jupyter Notebook that acts as the root of a Jupyter Network for this subscriber, an instance of the subscriber web session interactions tracker record (of FIG. 10). As such, the process can include steps for generating a unique subscriber ID that is appended to a subscriber name 1002, a unique security token 1004 for authenticating the subscriber and the subscriber profile 1006. The subscriber profile 1006 can include data about an individual (e.g., characteristics and age), list of entitlements together with their associated SLAs, and list of registered devices that can access the service. In addition, an initial list of websites that the subscriber is interested in automatically tracking can be specified in tracked websites 1008, a session counter 1010 can be set to 0 and the list of web sessions 1012 can be set to point to the (currently empty) table implementing the web interaction session model of FIG. 10. The dialog highlights index 1014, insights index 1016, focus index 1018, and transactions index 1020 data fields, which point to sorted lists of the artifacts created by the subscriber and/or the services, can also be set to nil.

The registration process can also create a cloud-based instance of the (cross-domain) tracking tags 911 and pixel tags 913 of the subscriber. The tracking tags 911 and pixel tags 913 can act as client-side tags for the web browsing through memory augmentation services scenarios of FIG. 6 and FIG. 7. Furthermore, the tracking tags 911 and pixel tags 913 can be used as a buffer for the data transmitted back and forth between the browser or mobile applications and the cloud-based memory augmentation servers.

A user authentication component 918 of the memory augmentation access services 902 can be invoked when a subscriber logs to the service. The user registry 916 can be consulted in order to verify the identity of the subscriber. The user entitlement validation component 920 can be used to confirm the class of services the subscriber is entitled to. Furthermore, a tracking tag can be created on the registered access device if it does not exist on the device. Otherwise, the data content of the tracking tag can be reset in order to prepare for the start of a new web interaction session.

A web interaction session can be assigned a unique web session ID that is based on the subscriber's name plus ID, a session ID that reflects the number of web interaction sessions logged by the subscriber and binary flags that capture the state of the services offered by memory augmentation. Thus, according to an implementation:

### Web Session ID=Subscriber Name+ID-Session ID-Summarization Flag-Annotation Flag-Dialog Management Flag

As it relates to the memory augmentation processing services 906, opening a web browser or starting a mobile application that support memory augmentation services marks the start of a web/chat interaction session with a web session ID derived by incrementing the subscriber's web session counter by 1. Closing the web browser or stopping a mobile application marks the end of a web interaction session. Changing the configuration of the services by switching on and off one or more of the summarization, annotation, and dialog management flags can start a new web/chat interaction session with the same subscriber name plus ID and web session ID. In addition, keying in a new website address that is distinct from the current website results in a new web session ID which modifies the current web session ID and marks the start of a new web interaction session. When a website is visited for the first time, its address and the services configuration can be added to the subscriber's list of tracked websites. Connecting the webpages visited in the current web session to those visited in prior sessions, can be performed upon or after the session is ended and can involve a single webpage or a path through previous Jupyter Notebooks. In parallel, a concise, updated map of the journeys of a subscriber through the website can be continually updated by the code embedded in the Jupyter Notebook used to derive the preferences of subscribers.

It is assumed that tracking the addresses of the websites and webpages that can be visited by a subscriber is permanently enabled except when prohibited by the browser mode of operation (e.g., do not track feature set on) or local laws. It is also assumed that cart and wish list management for e-commerce sites are not impacted by memory augmentation services, which track their transactions when the subscriber is logged in. Moving from one webpage to another is captured by the tracking tag and stored in the user web/chat sessions data store 922. The list of items transferred to a shopping cart or a wish list (e.g., user cart/wish list data stores 924) and transactions performed on behalf of the subscriber can be captured at the website level and added to website cart/wish list 1022 of the visited website data model 1024 of FIG. 10. They can be also stored in the user web/chat sessions data store 922.

In order to track and process the artifacts of a web session or a chat session, the web/chat session interaction manager component 928 is invoked by the web browser plugin or the mobile application. This web/chat session interaction manager component 928 is responsible for continually polling and/or getting interrupts from the subscriber tracking and pixel tags in order to update, when the associated service is enabled, the visitor's annotations, dialog segments and summaries of webpages and/or chat rooms. A processing services scheduler component 930 can be used to process these updates and store the results in the visited webpage data model 1026 of FIG. 10 and stored in the user web/chat sessions artifacts data store.

When summarization is enabled, the web/chat session interaction manager component 928 can invoke the web/chat session summarization manager component 932, which in turn launches the summarization application selected during memory augmentation services setup and configuration. The web/chat session summarization manager component 932 can retrieve the sequence of webpages visited by the subscriber that can be stored in user web/chat sessions data store 922 in order to create pointers to existing webpage and website summaries that were created by the service for other subscribers, or to schedule the creation of new summaries. Scheduling the creation of new webpage, website, and web session summaries can be facilitated by the processing services scheduler component 930, based on subscribers' entitlements.

New and updated webpage summaries 1027 can be added to webpage summaries of the visited webpage data model 1026 of FIG. 10. On the other hand, websites can have a number of summaries that reflect the distinctive sequence of webpages visited by a subscriber browsing through these websites. These summaries can be stored in website focus 1028 of the visited website data model 1024 of FIG. 10. Summaries of web sessions can be added to the cross-site focus data field 1030 of the web interactions session data model 1040 of FIG. 10, and a focus index can be continually updated to build a sorted list of these cross-site focus entries 1031 in subscriber web session interactions tracker data model FIG. 10. The above results can be saved in the user web/chat interactions artifacts data store 926 of FIG. 9.

When annotation is enabled, the web/chat session interaction manager component 928 invokes the web/chat session annotation services component 934 which in turn launches the annotation application selected during memory augmentation services setup and configuration. Annotation is facilitated through a set of windows that can be displayed when webpages are loaded. An annotation window is associated with one or more webpage, website, or web session. This window is automatically closed whenever a subscriber navigates away from a webpage. Windows associated with websites and web sessions need to be explicitly closed by the subscriber. Once closed, the content of a window is saved to the user web/chat interactions artifacts data store 926.

New and updated webpage annotations can be added to webpage visitor annotations 1032 of the visited webpage data model 1026 of FIG. 10. On the other hand, websites can have a number of annotations that reflect the distinctive sequence of webpages visited by a subscriber browsing through these websites. These annotations can be stored in website insights 1034 of the visited website data model 1024 of FIG. 10. Annotations of web session can be added to the cross-site insights data field 1036 of the web interactions session data model 1040 of FIG. 10, and an insights index can be continually updated to build a sorted list of these cross-site insights entries in subscriber web session interactions tracker data model (e.g., the web interactions session data model 1040) of FIG. 10. The above results can be saved in the user web/chat interactions artifacts data store 926.

When dialog management is enabled, the web/chat session interaction manager component 928 can invoke the web/chat session dialog manager component 927, which in turn launches the dialog management application selected during memory augmentation services setup and configuration. The web/chat session dialog manager component 927 can retrieve the sequence of webpages visited by the subscriber that can be stored in user web/chat sessions data store 922 in order to schedule the analysis of dialog segments. Scheduling the creation of new webpage, website, and web session dialog segments can be performed by the processing services scheduler component 930 based on subscribers' entitlements. Results can be saved in the user web/chat interactions artifacts data store 926 of FIG. 9.

New and updated webpage dialog segments can be added to webpage visitor dialog segments 1038 of the visited webpage data model 1026 of FIG. 10. On the other hand, websites can have a number of dialog segments that reflect the distinctive sequence of webpages visited by a subscriber browsing through these websites. These dialog segments can be stored in website dialog highlights 1039 of the visited website data model 1024 of FIG. 10. Dialog segments of web session can be added to the cross-site dialog highlights data field 1042 of the web interactions session data model 1040 of FIG. 10, and a dialog highlights index can be continually updated to build a sorted list of these cross-site dialog highlights entries in subscriber web session interactions tracker data model of FIG. 10. The above results can be saved in the user web/chat interactions artifacts data store 926 of FIG. 9.

The unique web session ID 1043 acts as a primary key for the web interaction session data model in FIG. 10. In addition, the interaction start time 1044 can be used to denote the start of the web session, interaction end time 1046 can be used to denote the end of this web session and the list of visited website 1048 denotes the list of visited websites. On the other hand, the website URL 1050, visit start time 1052, and visit end time 1054 of visited websites 1055 can be used to distinguish multiple visits to the same website within a web session. Similarly, the webpage URL 1056, webpage visit start time 1058, and webpage visit end time 1060 of visited webpages can be used to distinguish multiple visits to the same webpage within a website.

As it relates to the memory augmentation support services 908, during the process, a web/chat session progress monitor component 936 can receive requests for information from subscribers and/or proactively sends subscribers information deemed helpful to their current web session activities. An artifact semantic analyzer 938 handles these requests using the data stored in the user web/chat interactions artifacts data store 926 and the user cart/wish list data stores 924 when the search is restricted to the historical records collected by the memory augmentation services. When the search involves the current active web interaction session, the summaries, annotations and dialog segments created while the web session is in progress are searched. A response composer 940 can be utilized to proactively formulate a set of recommendations that can be pulled by subscribers and/or proactively pushed by the system.

The data model of FIG. 10 is designed to enable sophisticated analytics. By collecting access times of various web interaction sessions, visited websites, and visited webpages, the browsing history of a subscriber can be constructed. Such a history can be correlated with their comments, observations, and interactive dialogs with a website human and/or virtual agent in order to follow-up with targeted offers, in coordination with a website's owner. The same information can also be used for subscribers to negotiate better prices with website owners that can be based on the information collected during a web interaction session from other websites as well as data collected from other public sources by the memory augmentation services. Indexed lists of dialog highlights, insights, focus areas and transactions can be created by memory augmentation services at the web interaction session level in order to speed-up pro-active searches for information whenever a subscriber revisits a website or requests searching existing information because of its relevance to a new website that he/she are currently visiting.

In order to speed-up the search and retrieval of summaries, annotations and dialog segments, they can be sorted by topic/goal, access time, web session and website. These sorted lists can be used to alert subscribers to information that is relevant to an ongoing discussion/negotiation (push mode) or to prepare for future discussions/negotiations (pull mode).

Virtual showrooms offer a visual means for memory augmentation services to interact with subscribers, especially via smartphones. A virtual showroom can be assigned to one or more subscribers and offers them a modular display comprising multiple sections that reflect current orders, wish lists and recommendations. The layout of one or more sections can comprise virtual shelves that display similar items that can be offered by multiple e-commerce partners and allow easy access to complementary items that could be of interest. The showroom can be continually refreshed with items that have been requested by the consumer or have been recommended by the services. Subscribers can also revisit their previous orders, wish lists and recommendations, dating to the time they joined the service. As such, the history of transactions with a specific e-commerce website can be captured and displayed in the showroom. Hovering over a displayed item can retrieve its attributes, which can be then displayed to allow for visually comparing similar attributes.

A multi-site transaction manager 950 can manage respective transactions associated with one or more sites. For example, a web session multi-site showroom manager 952 can provide a showroom across multiple sites. Further, a web session multi-site payment processor 954 can facilitate purchases at one or more sites.

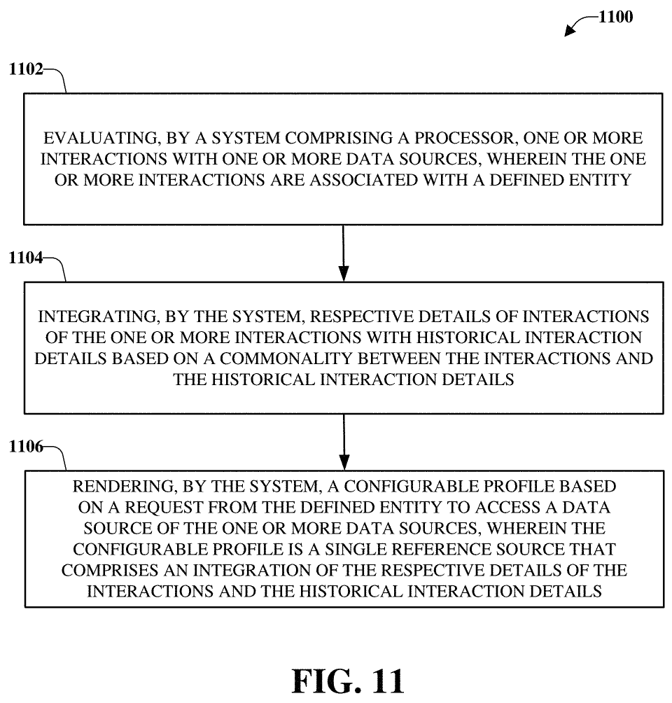

FIG. 11 illustrates a flow diagram of an example, non-limiting, computer-implemented method 1100 that facilitates memory augmentation in support of web interaction in accordance with one or more embodiments described herein. Repetitive description of like elements employed in other embodiments described herein is omitted for sake of brevity.

At 1102 of the computer-implemented method 1100, a system operatively coupled to one or more processors, can evaluate one or more interactions with one or more data sources (e.g., via the analysis component 102). The one or more interactions can be associated with an entity. According to some implementations, the one or more interactions can comprise inputs received from the entity and outputs provided by the one or more data sources. The inputs and the outputs can be represented as data streams. Based on the data streams being related to free-flowing chats, the data streams can be independently evaluated. When the data streams being related to structured web surfing, the data streams can be evaluated as a set.

The details of ongoing interactions between entities and data sources with past (or historical) interactions between the same parties can be integrated at 1104 of the computer-implemented method 1100 (e.g., via the augmentation component 104). The integration can take multiple forms including the creation and management of the full history of such interactions as sorted lists of time-stamped events that reflect commonalities such as context and topic.

Further, at 1106 of the computer-implemented method 1100, a single reference source that integrates ongoing interactions with past interactions between the same parties can be rendered (e.g., via the output component 106).

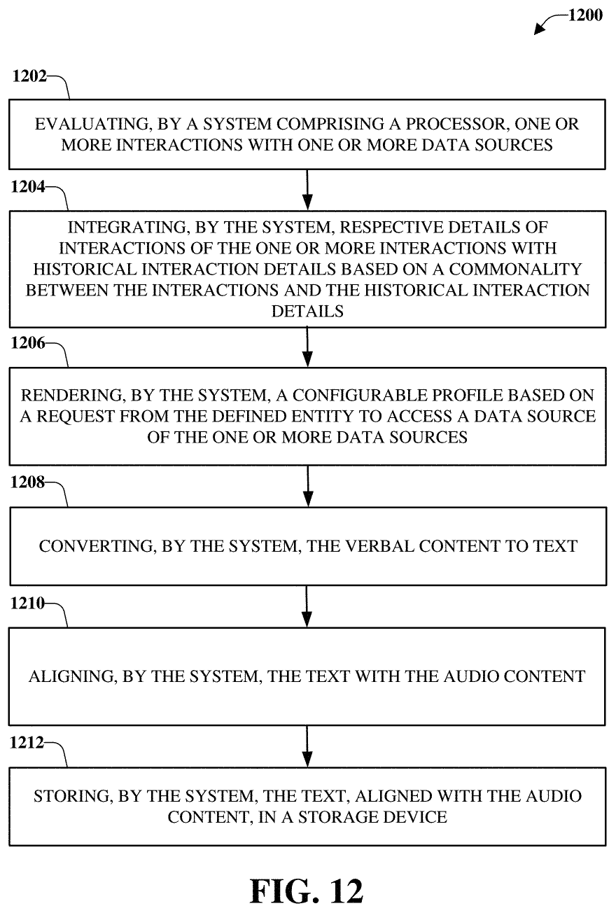

FIG. 12 illustrates a flow diagram of an example, non-limiting, computer-implemented method 1200 that facilitates memory augmentation for audio content and verbal content in accordance with one or more embodiments described herein. Repetitive description of like elements employed in other embodiments described herein is omitted for sake of brevity.

At 1202 of the computer-implemented method 1200, a system comprising a processor can evaluate one or more interactions with one or more data sources (e.g., via the analysis component 102). The one or more interactions can comprise inputs received from an entity and outputs provided by the one or more data sources. The inputs and the outputs can comprise audio content and verbal content.

The details of ongoing interactions between entities and data sources with past (or historical) interactions between the same parties can be integrated at 1204 of the computer-implemented method 1200 (e.g., via the augmentation component 104). The integration can take multiple forms including the creation and management of the full history of such interactions as sorted lists of time-stamped events that reflect commonalities such as context and topic. Further, at 1206 of the computer-implemented method 1200, a single reference source that integrates ongoing interactions with past interactions between the same parties can be rendered (e.g., via the output component 106).

At 1208 of the computer-implemented method 1200, verbal content can be translated into text (e.g., via the conversion component 202). Further, the text can be aligned with the audio content (e.g., via the arrangement component 204).

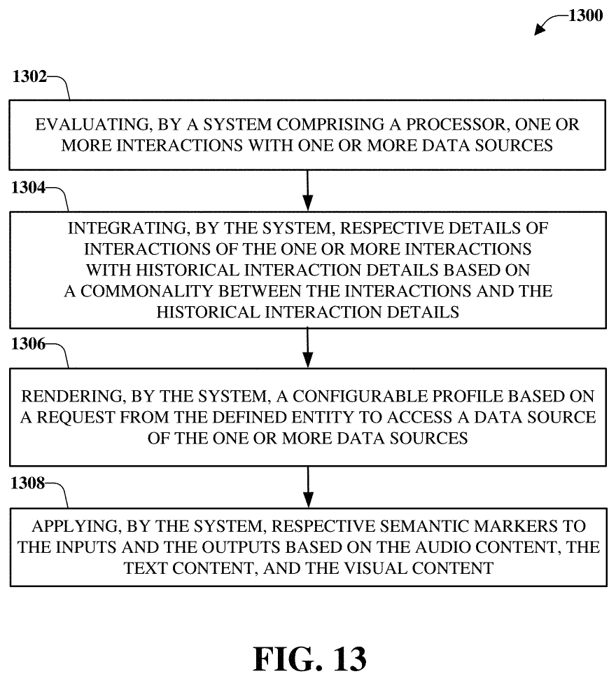

FIG. 13 illustrates a flow diagram of an example, non-limiting, computer-implemented method 1300 that facilitates memory augmentation for audio content, text content, and visual content in accordance with one or more embodiments described herein. Repetitive description of like elements employed in other embodiments described herein is omitted for sake of brevity.

At 1302 of the computer-implemented method 1300, a system comprising a processor can evaluate one or more interactions with one or more data sources (e.g., via the analysis component 102). The one or more interactions can comprise inputs received from an entity and outputs provided by the one or more data sources. The inputs and the outputs can comprise audio content, text content, and visual content.

The details of ongoing interactions between entities and data sources with past (or historical) interactions between the same parties can be integrated at 1304 of the computer-implemented method 1300 (e.g., via the augmentation component 104). The integration can take multiple forms including the creation and management of the full history of such interactions as sorted lists of time-stamped events that reflect commonalities such as context and topic. Further, at 1306 of the computer-implemented method 1300, a single reference source that integrates ongoing interactions with past interactions between the same parties can be rendered (e.g., via the output component 106).

At 1308 of the computer-implemented method 1300, respective semantic markers can be applied to the inputs and the outputs based on the audio content, the text content, and the visual content (e.g., via the indexing component 302).

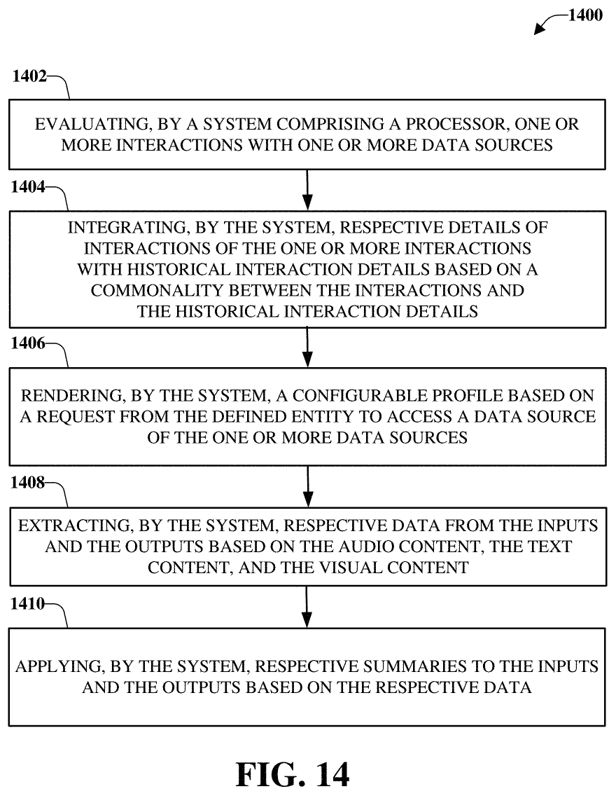

FIG. 14 illustrates a flow diagram of an example, non-limiting, computer-implemented method 1400 that facilitates insights associated with memory augmentation for audio content, text content, and visual content in accordance with one or more embodiments described herein. Repetitive description of like elements employed in other embodiments described herein is omitted for sake of brevity.

At 1402 of the computer-implemented method 1400, a system comprising a processor can evaluate one or more interactions with one or more data sources (e.g., via the analysis component 102). The one or more interactions can comprise inputs received from the defined entity and outputs provided by the one or more data sources. The inputs and the outputs can comprise audio content, text content, and visual content.

The details of ongoing interactions between entities and data sources with past (or historical) interactions between the same parties can be integrated at 1404 of the computer-implemented method 1400 (e.g., via the augmentation component 104). The integration can take multiple forms including the creation and management of the full history of such interactions as sorted lists of time-stamped events that reflect commonalities such as context and topic. Further, at 1406 of the computer-implemented method 1400, a single reference source that integrates ongoing interactions with past interactions between the same parties can be rendered (e.g., via the output component 106).

At 1408 of the computer-implemented method 1400, respective data from the inputs and the outputs can be extracted (e.g., via the parse component 402). For example, the respective data can be extracted based on the audio content, the text content, and the visual content. Further, at 1410 of the computer-implemented method 1400, respective summaries can be applied to the inputs and the outputs based on the respective data (e.g., via the annotation component 404).

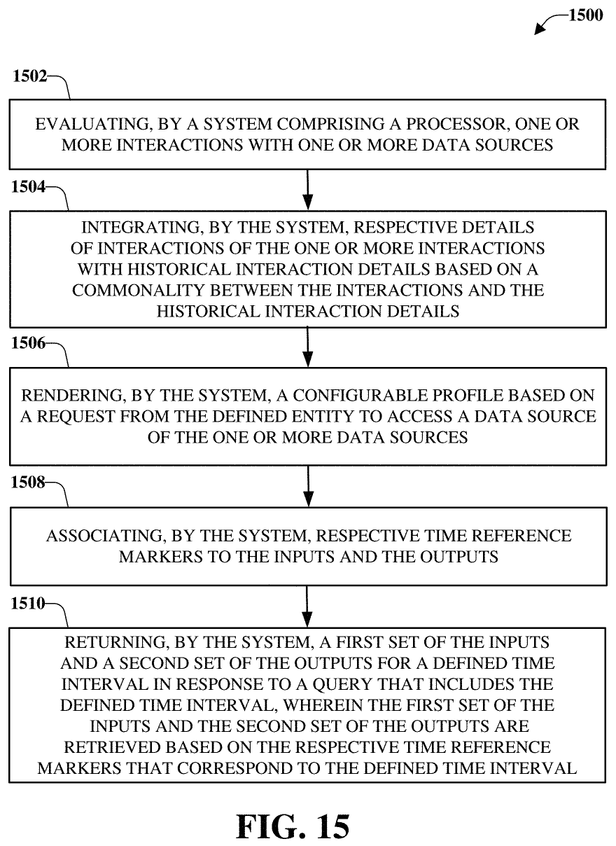

FIG. 15 illustrates a flow diagram of an example, non-limiting, computer-implemented method 1500 that facilitates memory augmentation for sets of inputs and outputs during a defined time interval in accordance with one or more embodiments described herein. Repetitive description of like elements employed in other embodiments described herein is omitted for sake of brevity.

At 1502 of the computer-implemented method 1500, a system comprising a processor can evaluate one or more interactions with one or more data sources (e.g., via the analysis component 102). The one or more interactions can comprise inputs received from the defined entity and outputs provided by the one or more data sources.

The details of ongoing interactions between entities and data sources with past (or historical) interactions between the same parties can be integrated at 1504 of the computer-implemented method 1500 (e.g., via the augmentation component 104). The integration can take multiple forms including the creation and management of the full history of such interactions as sorted lists of time-stamped events that reflect commonalities such as context and topic. Further, at 1506 of the computer-implemented method 1500, a single reference source that integrates ongoing interactions with past interactions between the same parties can be rendered (e.g., via the output component 106).

At 1508 of the computer-implemented method 1500, respective time reference markers can be associated with the inputs and the outputs (e.g., via the reference component 502). A first set of the inputs and a second set of the outputs for a defined time interval can be returned, at 1510 of the computer-implemented method 1500 in response to a query that includes the defined time interval (e.g., via the interaction component 504). The first set of the inputs and the second set of the outputs can be retrieved based on the respective time reference markers that correspond to the defined time interval.

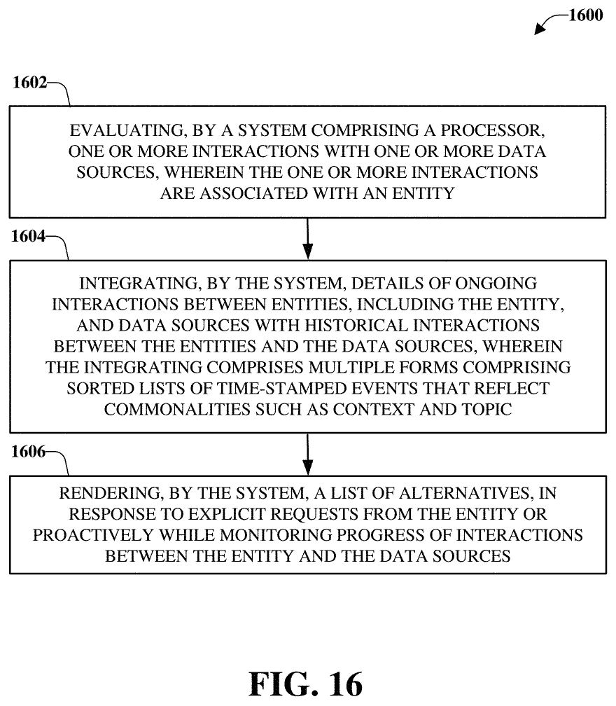

FIG. 16 illustrates a flow diagram of an example, non-limiting, computer-implemented method 1600 for memory augmentation in accordance with one or more embodiments described herein. Repetitive description of like elements employed in other embodiments described herein is omitted for sake of brevity.

At 1602 of the computer-implemented method 1600, evaluating, by a system comprising a processor, one or more interactions with one or more data sources (e.g., via the analysis component 102). The one or more interactions can be associated with an entity.

Further, at 1604 of the computer-implemented method 1600, integrating, by the system, details of ongoing interactions between entities, including the entity, and data sources with historical interactions between the entities and the data sources. In an example, the integrating can be of the details of ongoing interactions between entities and data sources with past (or historical) interactions between the same parties. The integrating can comprise multiple forms comprising sorted lists of time-stamped events that reflect commonalities such as context and topic and/or creation and management of the full history of such interactions as sorted lists of time-stamped events that reflect commonalities such as context and topic

At 1606 of the computer-implemented method 1600, rendering, by the system, a list of alternatives, in response to explicit requests from the entity or proactively while monitoring progress of interactions between the entity and the data sources. The list of alternatives can be a single reference source that comprises an integration of the respective details of the interactions and the historical interaction details.

If memory augmentation is enabled by an Internet website or chat room, a significant number of the artifacts that are used in interactions between visitors and the website or the chat room can be generated and continually updated. This backend processing can help improve the overall scalability and performance of the system.

According to an embodiment, a system can comprise a memory that stores computer executable components and a processor that executes the computer executable components stored in the memory. The computer executable components can comprise an analysis component that can evaluate one or more interactions with one or more data sources. The one or more interactions can be associated with an entity. The computer executable components can also comprise an augmentation component that can integrate respective details of interactions of the one or more interactions with historical interaction details based on a commonality between the interactions and the historical interaction details. The historical interaction details can be retained in a storage device. Further, the computer executable components can comprise an output component that can render a configurable profile based on a request from the entity to access a data source of the one or more data sources. The configurable profile can be a single reference source that comprises an integration, by the augmentation component, of the respective details of the interactions and the historical interaction details.

According to another embodiment, a computer-implemented method can comprise evaluating, by a system operatively coupled to a processor, one or more interactions with one or more data sources, wherein the one or more interactions can be associated with a defined entity. The computer-implemented method can also comprise integrating, by the system, respective details of interactions of the one or more interactions with historical interaction details based on a commonality between the interactions and the historical interaction details. Further, the computer-implemented method can comprise rendering, by the system, a configurable profile based on a request from the defined entity to access a data sources of the one or more data sources. The configurable profile can be a single reference source that comprises an integration of the respective details of the interactions and the historical interaction details.

According to another embodiment, a computer program product that provides memory augmentation services can comprise a computer readable storage medium having program instructions embodied therewith. The program instructions can be executable by a processing component. The program instructions can cause the processing component to evaluate one or more interactions with one or more data sources. The one or more interactions can be associated with a defined entity. The program instructions can also cause the processing component to integrate respective details of interactions of the one or more interactions with historical interaction details based on a commonality between the interactions and the historical interaction details. The historical interaction details can be retained in a storage device. Further, the program instructions can cause the processing component to render a configurable profile based on a request from the defined entity to access a data sources of the one or more data sources. The configurable profile can be a single reference source that comprises an integration of the respective details of the interactions and the historical interaction details.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

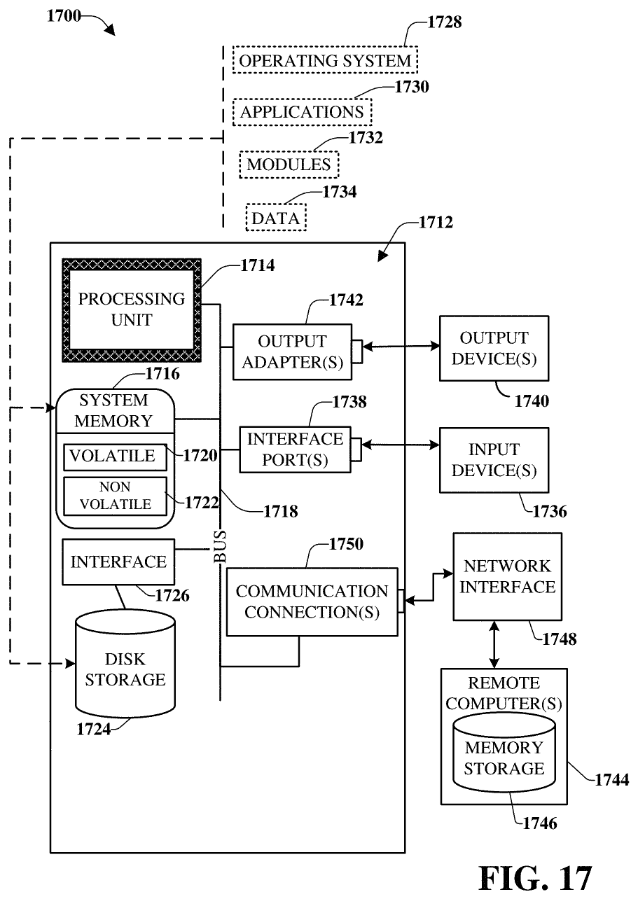

In order to provide a context for the various aspects of the disclosed subject matter, FIG. 17 as well as the following discussion are intended to provide a general description of a suitable environment in which the various aspects of the disclosed subject matter can be implemented. FIG. 17 illustrates a block diagram of an example, non-limiting operating environment in which one or more embodiments described herein can be facilitated. Repetitive description of like elements employed in other embodiments described herein is omitted for sake of brevity. With reference to FIG. 17, a suitable operating environment 1700 for implementing various aspects of this disclosure can also include a computer 1712. The computer 1712 can also include a processing unit 1714, a system memory 1716, and a system bus 1718. The system bus 1718 couples system components including, but not limited to, the system memory 1716 to the processing unit 1714. The processing unit 1714 can be any of various available processors. Dual microprocessors and other multiprocessor architectures also can be employed as the processing unit 1714. The system bus 1718 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI). The system memory 1716 can also include volatile memory 1720 and nonvolatile memory 1722. The basic input/output system (BIOS), containing the basic routines to transfer information between elements within the computer 1712, such as during start-up, is stored in nonvolatile memory 1722. By way of illustration, and not limitation, nonvolatile memory 1722 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1720 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1712 can also include removable/non-removable, volatile/nonvolatile computer storage media. FIG. 17 illustrates, for example, a disk storage 1724. Disk storage 1724 can also include, but is not limited to, devices like a magnetic disk drive, floppy disk drive, tape drive, Jaz drive, Zip drive, LS-100 drive, flash memory card, or memory stick. The disk storage 1724 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1724 to the system bus 1718, a removable or non-removable interface is typically used, such as interface 1726. FIG. 17 also depicts software that acts as an intermediary between users and the basic computer resources described in the suitable operating environment 1700. Such software can also include, for example, an operating system 1728. Operating system 1728, which can be stored on disk storage 1724, acts to control and allocate resources of the computer 1712. System applications 1730 take advantage of the management of resources by operating system 1728 through program modules 1732 and program data 1734, e.g., stored either in system memory 1716 or on disk storage 1724. It is to be appreciated that this disclosure can be implemented with various operating systems or combinations of operating systems. A user enters commands or information into the computer 1712 through input device(s) 1736. Input devices 1736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1714 through the system bus 1718 via interface port(s) 1738. Interface port(s) 1738 include, for example, a serial port, a parallel port, a game port, and a universal serial bus (USB). Output device(s) 1740 use some of the same type of ports as input device(s) 1736. Thus, for example, a USB port can be used to provide input to computer 1712, and to output information from computer 1712 to an output device 1740. Output adapter 1742 is provided to illustrate that there are some output devices 1740 like monitors, speakers, and printers, among other output devices 1740, which require special adapters. The output adapters 1742 include, by way of illustration and not limitation, video and sound cards that provide a method of connection between the output device 1740 and the system bus 1718. It should be noted that other devices and/or systems of devices provide both input and output capabilities such as remote computer(s) 1744.

Computer 1712 can operate in a networked environment using logical connections to one or more remote computers, such as remote computer(s) 1744. The remote computer(s) 1744 can be a computer, a server, a router, a network PC, a workstation, a microprocessor based appliance, a peer device or other common network node and the like, and typically can also include many or all of the elements described relative to computer 1712. For purposes of brevity, only a memory storage device 1746 is illustrated with remote computer(s) 1744. Remote computer(s) 1744 is logically connected to computer 1712 through a network interface 1748 and then physically connected via communication connection 1750. Network interface 1748 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1750 refers to the hardware/software employed to connect the network interface 1748 to the system bus 1718. While communication connection 1750 is shown for illustrative clarity inside computer 1712, it can also be external to computer 1712. The hardware/software for connection to the network interface 1748 can also include, for exemplary purposes only, internal and external technologies such as, modems including regular telephone grade modems, cable modems and DSL modems, ISDN adapters, and Ethernet cards.

The present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create method for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. The characteristics are as follows: on-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a high level of abstraction (e.g., country, state, or data center). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of selected networking components (e.g., host firewalls).

Deployment Models are as follows: Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises. Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

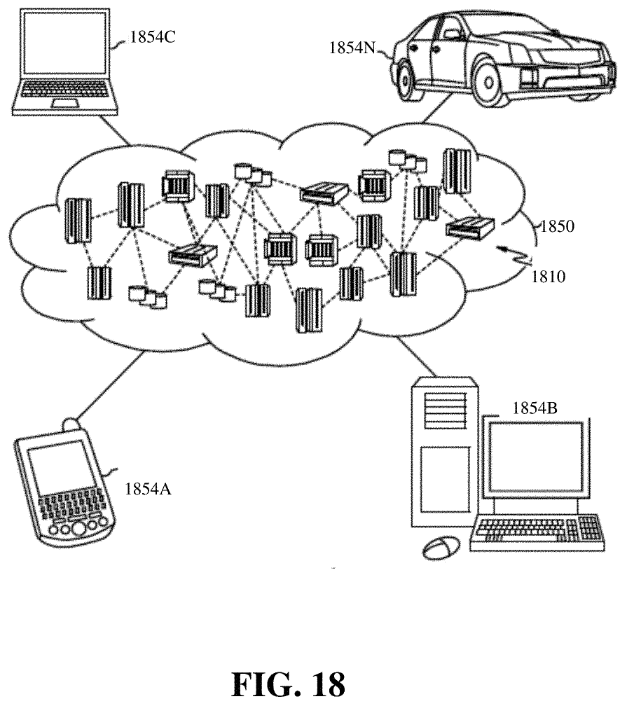

Referring now to FIG. 18, illustrative cloud computing environment 1850 is depicted. As shown, cloud computing environment 1850 includes one or more cloud computing nodes 1810 with which local computing devices used by cloud consumers, such as, for example, personal digital assistant (PDA) or cellular telephone 1854A, desktop computer 1854B, laptop computer 1854C, and/or automobile computer system 1854N may communicate. Nodes 1810 may communicate with one another. They may be grouped (not shown) physically or virtually, in one or more networks, such as Private, Community, Public, or Hybrid clouds as described hereinabove, or a combination thereof. This allows cloud computing environment 1850 to offer infrastructure, platforms and/or software as services for which a cloud consumer does not need to maintain resources on a local computing device. It is understood that the types of computing devices 1854A-N shown in FIG. 18 are intended to be illustrative only and that computing nodes 1810 and cloud computing environment 1850 can communicate with any type of computerized device over any type of network and/or network addressable connection (e.g., using a web browser).

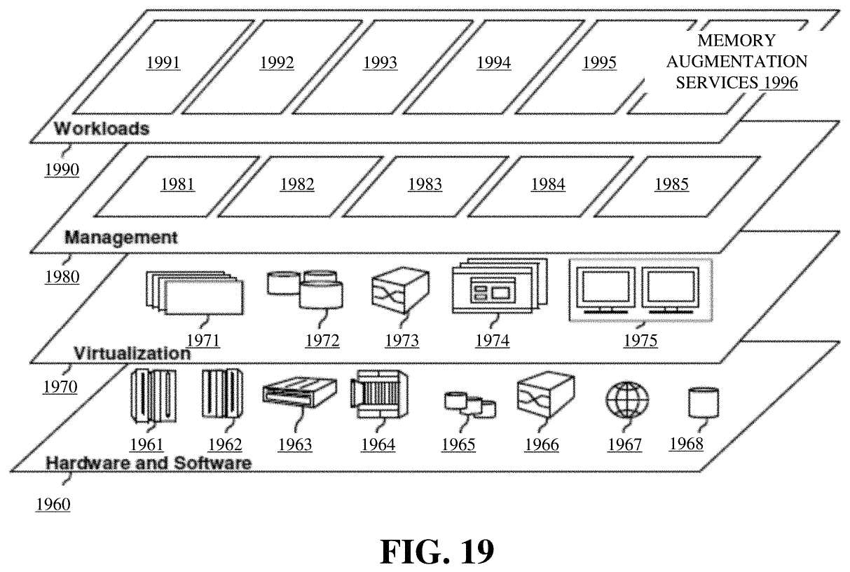

Referring now to FIG. 19, a set of functional abstraction layers provided by cloud computing environment 1850 (FIG. 18) is shown. It should be understood in advance that the components, layers, and functions shown in FIG. 19 are intended to be illustrative only and embodiments of the invention are not limited thereto. As depicted, the following layers and corresponding functions are provided: Hardware and software layer 1960 includes hardware and software components. Examples of hardware components include: mainframes 1961; RISC (Reduced Instruction Set Computer) architecture based servers 1962; servers 1963; blade servers 1964; storage devices 1965; and networks and networking components 1966. In some embodiments, software components include network application server software 1967 and database software 1968.

Virtualization layer 1970 provides an abstraction layer from which the following examples of virtual entities may be provided: virtual servers 1971; virtual storage 1972; virtual networks 1973, including virtual private networks; virtual applications and operating systems 1974; and virtual clients 1975.

In one example, management layer 1980 may provide the functions described below. Resource provisioning 1981 provides dynamic procurement of computing resources and other resources that are utilized to perform tasks within the cloud computing environment. Metering and Pricing 1982 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1983 provides access to the cloud computing environment for consumers and system administrators. Service level management 1984 provides cloud computing resource allocation and management such that required service levels are met. Service Level Agreement (SLA) planning and fulfillment 1985 provide pre-arrangement for, the procurement of, cloud computing resources for which a future requirement is anticipated in accordance with an SLA.

Workloads layer 1990 provides examples of functionality for which the cloud computing environment may be utilized. Examples of workloads and functions which may be provided from this layer include: mapping and navigation 1991; software development and lifecycle management 1992; virtual classroom education delivery 1993; data analytics processing 1994; transaction processing 1995; and memory augmentation services 1996.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other method to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
an analysis component that evaluates one or more interactions with one or more data sources, wherein the one or more interactions are associated with an entity, wherein data sources of the one or more data sources comprise one or more websites and one or more chatrooms, and wherein data sources capture one or more interactions of entities, including the entity, associated with visited websites and chatrooms;
an augmentation component that integrates details of ongoing interactions between the entities and the data sources with historical interactions between the entities and the one or more data sources, wherein integration by the augmentation component comprises multiple forms comprising sorted lists of time-stamped events that reflect commonalities such as context and topic, wherein the historical interactions are retained in a storage device; and
an output component that renders a list of alternatives, in response to explicit requests from the entity or proactively while monitoring progress of interactions between the entities and the data sources, wherein the list of alternatives is a single reference source that comprises the integration of the respective details of the interactions and the historical interactions.

2. The system of claim 1, wherein the augmentation component aggregates the respective details of the interactions and the historical interactions.

3. The system of claim 1, wherein the one or more interactions comprise inputs received from the entity and outputs provided by the one or more data sources.

4. The system of claim 3, wherein the inputs and the outputs are represented as data streams, and wherein the analysis component independently evaluates the data streams, wherein the data streams are related to free-flowing chats.

5. The system of claim 3, wherein the inputs and the outputs are represented as data streams, and wherein the analysis component evaluates the data streams as an aggregate set of data streams, wherein the data streams are related to structured web surfing.

6. The system of claim 3, wherein the inputs and the outputs comprise speech, text, image, video, touch, gesture, and annotations, or a combination thereof.

7. The system of claim 3, wherein the inputs and the outputs comprise audio content and verbal content, and wherein the computer executable components further comprise:
a conversion component that translates the verbal content to text; and
an arrangement component that aligns the text with the audio content, wherein the text, aligned with the audio content, is retained in the storage device.

8. The system of claim 1, wherein the one or more interactions comprise inputs received from the entity and outputs provided by the one or more data sources, wherein the inputs and the outputs comprise audio content, text content, and visual content, and wherein the computer executable components further comprise:
an indexing component that applies respective semantic markers to the inputs and the outputs based on the audio content, the text content, and the visual content.

9. The system of claim 1, wherein the one or more interactions comprise inputs received from the entity and outputs provided by the one or more data sources, wherein the inputs and the outputs comprise audio content, text content, and visual content, and wherein the computer executable components further comprise:
a parse component that extracts respective data from the inputs and the outputs based on the audio content, the text content, and the visual content; and
an annotation component that applies respective summaries to the inputs and the outputs based on the respective data.

10. The system of claim 1, wherein the one or more interactions comprise inputs received from the entity and outputs provided by the one or more data sources, and wherein the computer executable components further comprise:
a reference component that associates respective time reference markers to the inputs and the outputs; and
an interaction component that retrieves a first set of the inputs and a second set of the outputs for a defined time interval in response to a query that includes the defined time interval, wherein the first set of the inputs and the second set of the outputs are retrieved based on the respective time reference markers that correspond to the defined time interval.

11. The system of claim 1, wherein a configuration of the system facilitates processing efficiency based on the list of alternatives that provides one or more targeted search parameters, and wherein the configuration supports a native application that comprises a first connectivity configuration and a browser-based application that comprises a second connectivity configuration different from the first connectivity configuration.

12. The system of claim 1, wherein the one or more data sources are one or more websites browsed by the entity.

13. A computer-implemented method, comprising:
evaluating, by a system comprising a processor, one or more interactions with one or more data sources, wherein the one or more interactions are associated with an entity;
integrating, by the system, details of ongoing interactions between entities, including the entity, and data sources with historical interactions between the entities and the data sources, wherein the integrating comprises multiple forms comprising sorted lists of time-stamped events that reflect commonalities such as context and topic; and
rendering, by the system, a list of alternatives, in response to explicit requests from the entity or proactively while monitoring progress of interactions between the entity and the data sources.

14. The computer-implemented method of claim 13, wherein the one or more interactions comprise inputs received from the entity and outputs provided by the one or more data sources, wherein the inputs and the outputs comprise audio content and verbal content, and wherein the computer-implemented method further comprises:
converting, by the system, the verbal content to text;
aligning, by the system, the text with the audio content; and
storing, by the system, the text, aligned with the audio content, in a storage device.

15. The computer-implemented method of claim 13, wherein the one or more interactions comprise inputs received from the entity and outputs provided by the one or more data sources, wherein the inputs and the outputs comprise audio content, text content, and visual content, and wherein the computer-implemented method further comprises:
applying, by the system, respective semantic markers to the inputs and the outputs based on the audio content, the text content, and the visual content.

16. The computer-implemented method of claim 13, wherein the one or more interactions comprise inputs received from the entity and outputs provided by the one or more data sources, wherein the inputs and the outputs comprise audio content, text content, and visual content, and wherein the computer-implemented method further comprises:
extracting, by the system, respective data from the inputs and the outputs based on the audio content, the text content, and the visual content; and
applying, by the system, respective summaries to the inputs and the outputs based on the respective data.

17. The computer-implemented method of claim 13, wherein the one or more interactions comprise inputs received from the entity and outputs provided by the one or more data sources, and wherein the computer-implemented method further comprises:
associating, by the system, respective time reference markers to the inputs and the outputs; and
returning, by the system, a first set of the inputs and a second set of the outputs for a defined time interval in response to a query that includes the defined time interval, wherein the first set of the inputs and the second set of the outputs are retrieved based on the respective time reference markers that correspond to the defined time interval.

18. A computer program product that provides memory augmentation services, the computer program product comprising a computer readable storage medium having program instructions embodied therewith, the program instructions are executable by a processor to cause the processor to:
evaluate one or more interactions with one or more data sources, wherein the one or more interactions are associated with an entity;
integrate details of ongoing interactions between entities, including the entity, and data sources with historical interactions between the entities and the data sources, wherein integration of the details comprises multiple forms comprising sorted lists of time-stamped events that reflect commonalities such as context and topic; and
render a list of alternatives, in response to explicit requests from the entity or proactively while monitoring progress of interactions between the entity and the data sources, wherein the list of alternatives is a single reference source that comprises the integration of the respective details of the interactions and the historical interactions.

19. The computer program product of claim 18, wherein the one or more interactions comprise inputs received from the entity and outputs provided by the one or more data sources, wherein the inputs and the outputs are represented as data streams, and wherein the program instructions cause the processor to evaluate the data streams as an aggregate set of data streams.

20. The computer program product of claim 18, wherein the one or more interactions comprise inputs received from the entity and outputs provided by the one or more data sources, wherein the inputs and the outputs are represented as data streams, and wherein the program instructions cause the processor to independently evaluate the data streams.
